(19) United States
(12) Patent Application Publication
(10) Pub. No.: US 2024/0220330 A1
(43) Pub. Date: Jul. 4, 2024

(54) AUTOSCALING OF ELASTIC COMPUTE RESOURCES

(71) Applicant: Teradata US, Inc., San Diego, CA (US)

(72) Inventors: John Douglas Frazier, Ramona, CA (US); Vimalraj Panneerselvam, San Diego, CA (US)

(21) Appl. No.: 18/401,598

(22) Filed: Dec. 31, 2023

Related U.S. Application Data
(60) Provisional application No. 63/478,144, filed on Dec. 31, 2022.

(51) Int. Cl. G06F 9/50; G06F 16/2453

(52) U.S. Cl. CPC G06F 9/505; G06F 9/5072; G06F 16/2453; G06F 2209/501; G06F 2209/5014; G06F 2209/505

(57) ABSTRACT

A system may include a storage device. The system may include a plurality of processing nodes. The plurality of processing nodes communicates with the storage device. At least one processing node schedules a group of compute nodes to be active during a selected time window. The at least one processing node receives a query and determines that the query is to be executed by one of the plurality of processing nodes and the group of compute nodes. The at least one processing node schedules the query to be executed by the determined one of the plurality of processing nodes or the group of compute nodes. A method and computer-readable medium are also disclosed.

### CLAIM OF PRIORITY

This application claims the benefit of priority under 35 U.S.C. § 119(e) of U.S. Provisional Patent Application Ser. No. 63/478,144 filed on Dec. 31, 2022, which is hereby incorporated by reference herein in its entirety.

### BACKGROUND

While cloud-based database analytics systems allow resources, such as compute resources, to be dynamically adjusted to accommodate the needs of organizations, business continuity is directly impacted by the need for system downtime to accommodate compute resource expansions and contractions. Not only is the system unavailable during these times, but there is also some complexity involved in performing expansion and contraction on current cloud platforms. However short the interruption in service today, down time of any duration is no longer acceptable in cloud deployments for handling situations such as these: special short-notice exploratory projects; periodic surges in the work being run on the platform (month-end, Monday mornings, etc.); introducing new applications or departments onto a busy system; and erratic end-user queries, some which require unexpectedly high levels of resources.

Thus, it would be desirable to manage expansion and contractions of cloud-based resources to minimize system downtime.

### SUMMARY

According to one aspect of the disclosure, a system may include a storage device. The system may include a plurality of processing nodes. The plurality of processing nodes may communicate with the storage device. At least one processing node may schedule a group of compute nodes to be active during a selected time window. The at least one processing node may receive a query. The at least one processing node may determine that the query is to be executed by one of the plurality of processing nodes and the group of compute nodes. The at least one processing node may schedule the query to be executed by the determined one of the plurality of processing nodes or the group of compute nodes.

According to another aspect of the disclosure, a method may include scheduling, with a processor, a group of compute nodes to be active during a selected time window. The method may include receiving, with the processor, a query. The method may include determining, with the processor, that the query is to be executed by one of the plurality of processing nodes and the group of compute nodes. The method may include scheduling, with the processor, the query to be executed by the determined one of the plurality of processing nodes or the group of compute nodes.

According to another aspect of the disclosure, a computer-readable medium is encoded with a plurality of instructions executable by a processor. The plurality of instructions may include instructions to schedule a group of compute nodes to be active during a selected time window. The plurality of instructions may include instruction to receive a query. The plurality of instructions may include instructions to determine that the query is to be executed by one of the plurality of processing nodes and the group of compute nodes. The plurality of instructions may include instructions to schedule the query to be executed by the determined one of the plurality of processing nodes or the group of compute nodes.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module.

FIG. 5 is a block diagram of an example analytic environment.

FIG. 6 is a block diagram of an example compute operational group.

FIG. 7 is a block diagram of an example analytic environment using additional compute resources.

FIG. 8 is an operational flow diagram of example creation of a compute profile.

FIG. 9 an operational flow diagram of example operation of primary operation group during query execution.

FIG. 10 is an operational flow diagram of example operation of primary operation group during usage of a compute cluster group.

### DETAILED DESCRIPTION OF THE FIGURES

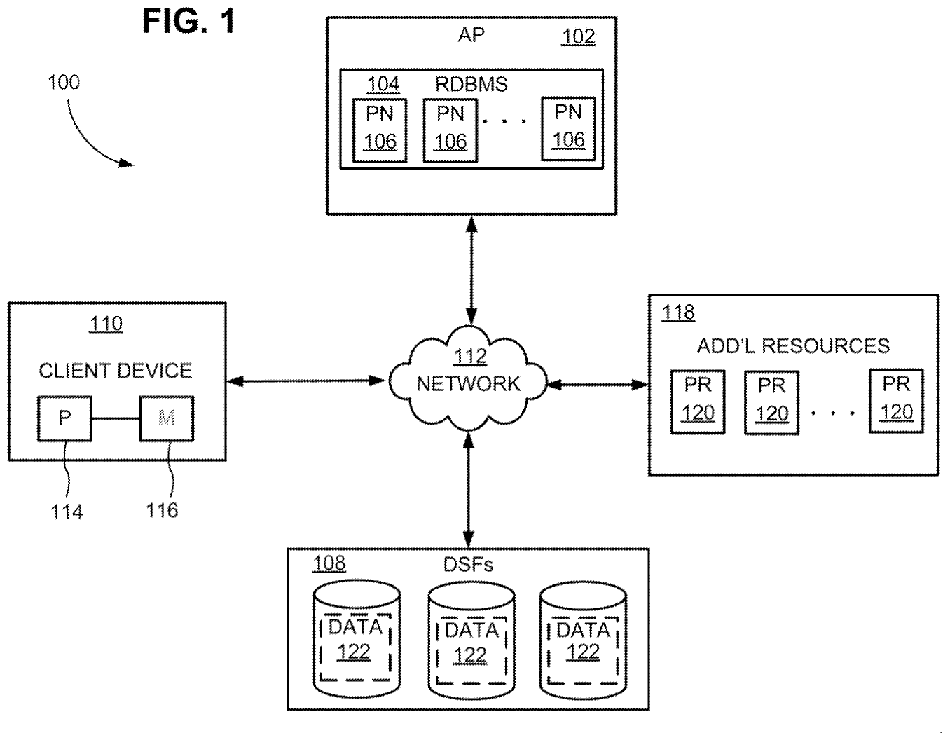

FIG. 1 is block diagram of an example analytic environment 100. In one example, the analytic environment 100 may include an analytic platform (“AP”) 102, such as Teradata Vantage. The analytic platform 102 may include one or more systems that may be used independently or with one another in carrying out advanced analytics. The analytic platform 102 may include a relational database management system (“RDBMS”) 104. In one example, the RDBMS 104 may implement a parallel-processing environment to carry out database management. The RDBMS 104 may be a combination of software (e.g., computer program routines, subroutines, applications, etc.) and hardware (e.g., processors, memory, etc.). In the example of FIG. 1, the RDBMS 104 may be a massive parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116. The network 112 may be wired, wireless, or some combination thereof. The network 112 may be a cloud-based environment, virtual private network, web-based, directly-connected, or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

In one example, a client device 110 may be used to submit tasks, such as database queries, to the analytic platform 102, which may be processed by the RDBMS 104. The client device may include one or more processors 114 and/or memory(ies) 116. During operation, the analytic platform 102 may implement the additional resources 118 in order to optimize execution of the various tasks received.

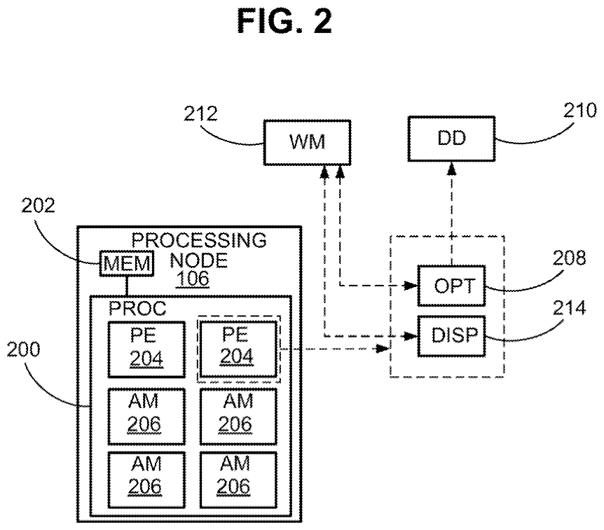

FIG. 2 is an example of a processing node 106, which may include one or more physical processors 200 and memory(ies) 202. The memory 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, that comprises instructions executable with the processor 200 or other processor to implement one or more of the features of the module. When any one of the modules includes the portion of the memory that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Active Data Warehousing System®.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIG. 1, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 102 stores data 122 in one or more tables in the DSFs 108. In one example, the data 122 may represent rows of stored tables are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

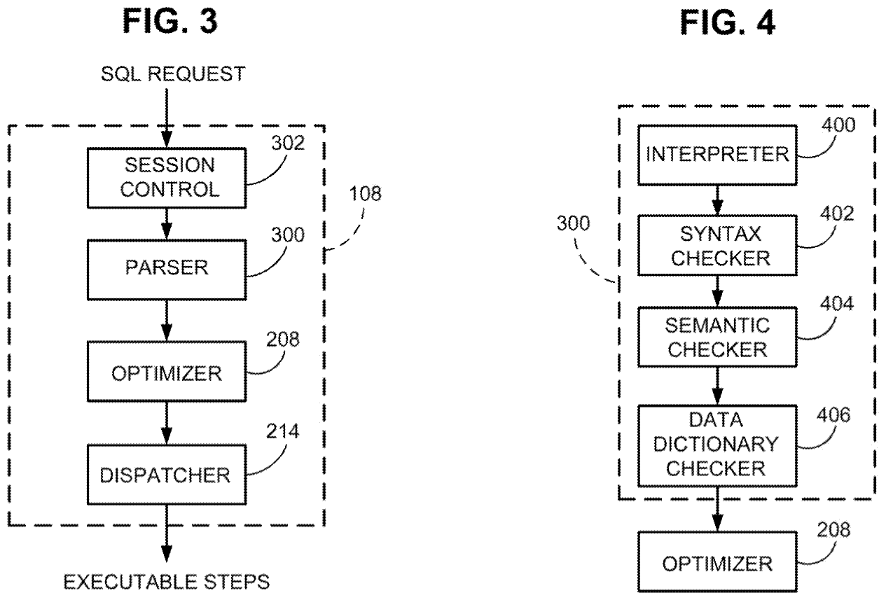

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 108 for purposes of illustration.

The data dictionary module 210 may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language models (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g., adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, an SQL request may be received such as through submission by a user and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

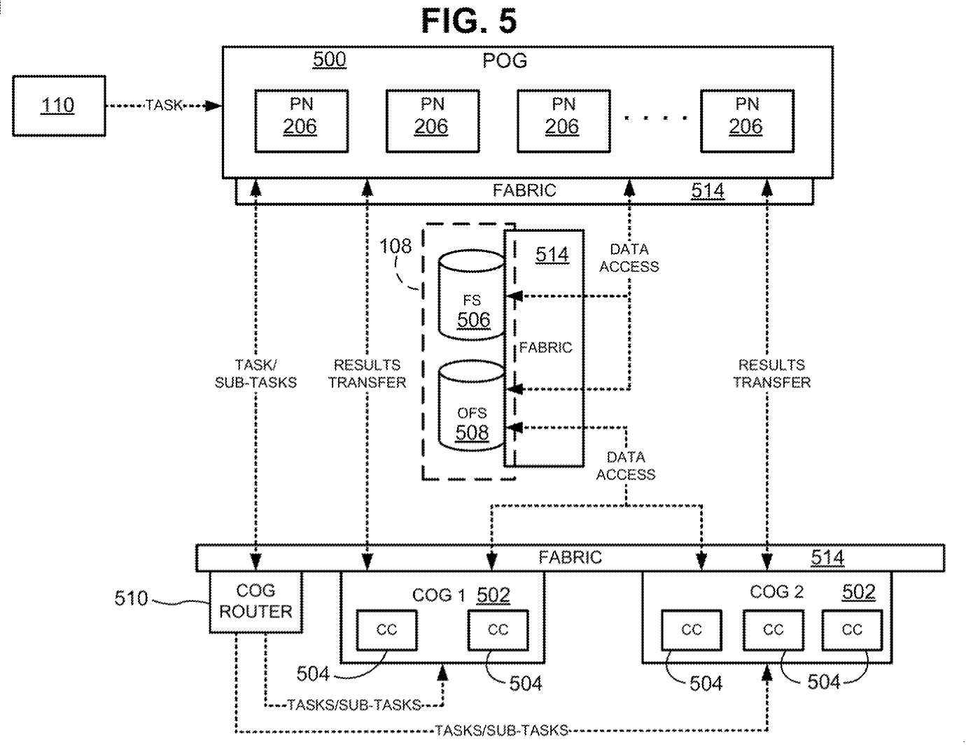

FIG. 5 is a block diagram of example implementation of the analytic environment 100. In one example, the analytic platform 102 may include one or more primary operation group (“POGs”) 500, which may include the RDBMS 104. In the example of FIG. 5, a single POG 500 is used as an example, but each analytic platform 102 may implement one or more POGs 500. The POG 500 may represent a plurality of processing nodes 206 that are persistently available to be used in order to conduct analytic and/or other tasks. Each POG 500 may represent an on-premises system, cloud-based, or some combination thereof. In one example, the analytic platform 100 may allow expansion of computing resources via the additional resources 118. In such a scenario, compute operation groups (“COGs”) 502 may be used as the additional resources 118. Each COG 502 may be associated with one or more compute clusters (“CC”) 504.

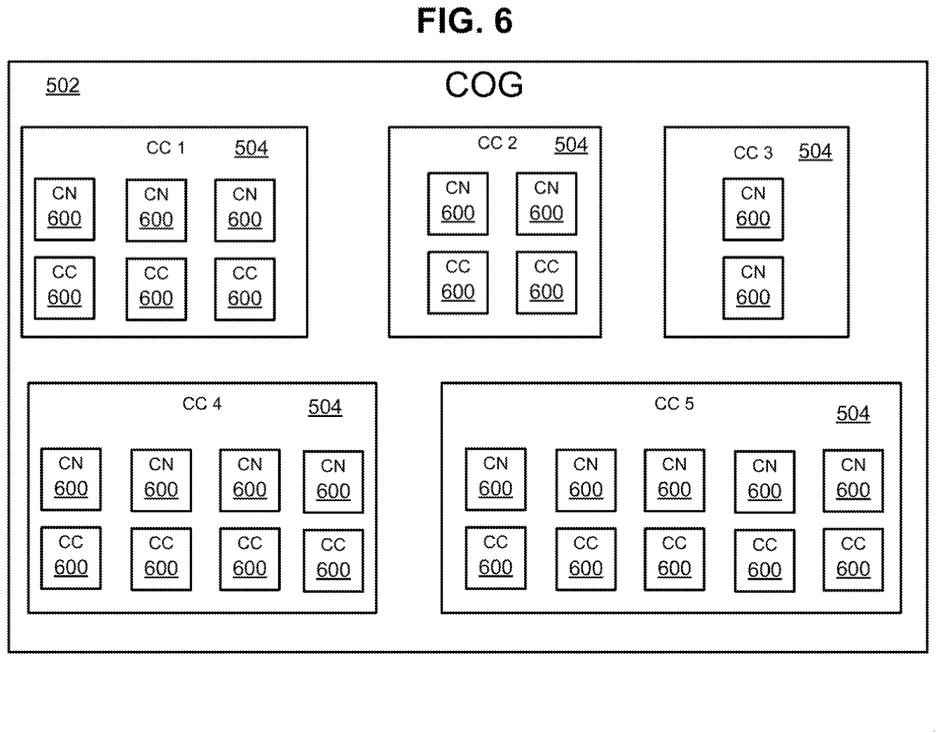

A compute cluster 504 may provide the functionality of a multi-processing-node instance, with each compute cluster 504 including one or more compute nodes 600 (see FIG. 6). Thus, A compute cluster 504 operates with compute nodes 600 that act similarly as multiple processing nodes 206, with each compute node 600 being capable of performing processing functions along with memory and networking capabilities. Each COG 502 may be associated with particular groups of compute clusters 504 that are associated with a particular characteristic of a task and/or query (e.g., department, user, and workload type). As shown in FIG. 6, each CC 504 may be created with a selected number of compute nodes 600. FIG. 6 is an example of a COG 502 that includes five compute clusters 504 (CC 1 through CG 5) each with a different number of compute nodes 600. The example of FIG. 6 is but one example of the number of compute clusters 504 that may be created. Moreover, the number of compute nodes 600 per cluster may be selected as well. In one example, predetermined sizes of compute clusters 504 may be established which allow the option to select a compute clusters 504 having a desired number of predetermined compute nodes 600.

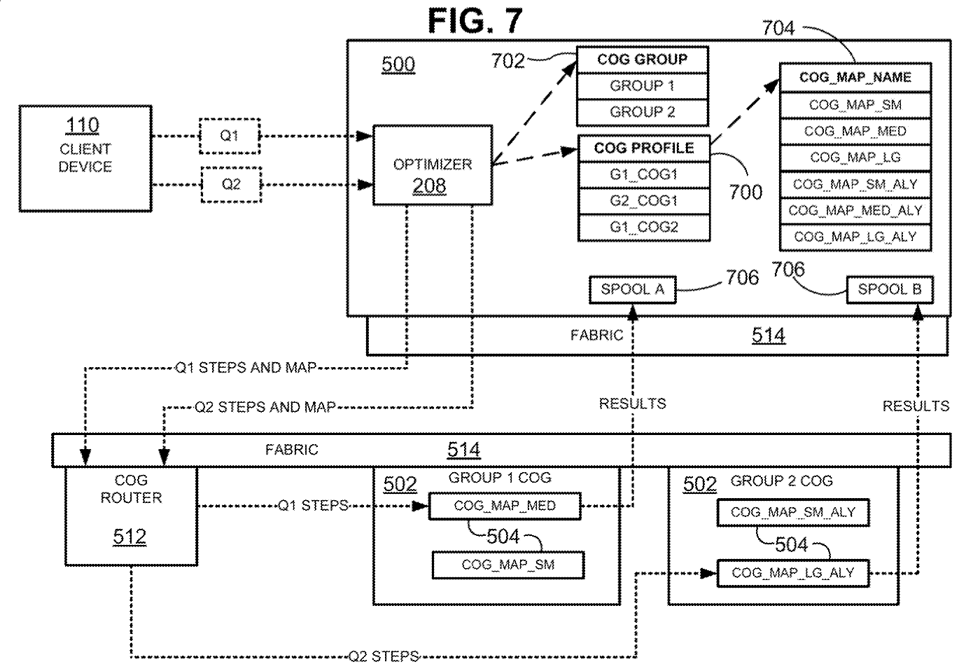

Each COG 502 may represent one or more compute profiles (see FIG. 7) with the same policy for assigning access and administration privileges to users. Each COG 502 may also set a number of concurrent queries that may run on a compute cluster 504 by establishing a query strategy, such as standard or analytic, for example. Each query strategy may establish how the compute capability may be utilized in each compute cluster 504, such a standard, analytic, graphical-processing-unit based, or other suitable strategy.

During operation, the POG 500 may receive a task, such as a query, from a client device 110. The POG 500 may determine whether or not the query is to be executed at the POG 500 or through use of the COGs 502. The DSFs 108 may include a file system (“FS”) 506 and shared storage (“SS”) 508. The file system 506 may only be accessible by the POGs 500 and the shared storage 506 may be accessible by the POG 500 and COGs 502. Thus, any queries involving data stored in the file system 506 will be exclusively handled by the POG 500. However, in instances where queries involve data stored in the shared storage 508, the POG 500 may send entire queries or query steps to the COGs 502 for execution in order to reduce the load on the POGs 500 and allow more expedient results.

Any tasks designated for the COGs 502 may be sent from the POGs 500 to a COG router 510. The COG router 510 may be software and/or hardware used to direct each received task to the designated compute cluster 504. The COG router 510 may be a standalone component or may be integrated into other components of the analytic environment 100. The POGs 500, compute clusters 504, DSFs 108, and COG router 506 may communicate with one another via fabric 514. The fabric 514 may represent appropriate connections allowing communication over the network 102. Any compute cluster 504 receiving tasks from the POGs 500 via the COG router 512 may send the results of the task execution back to the POGs 500 via the fabric 514.

FIG. 7 is an example of operation of the analytic environment 100 using multiple COGs 502. In one example, an optimizer 208 of the POG 500 may plan query responses for queries received via one or more client devices 110. During query planning, the optimizer 208 may determine if the POGs 500 are to execute the query or if COGs 502 are to be implemented.

In one example, compute clusters 504 may be instantiated as cloud-based computing resources during particular times in which workloads are expected to increase, which decreases the load on the POGs 500. In one example, compute profiles 700 may be maintained in the POGs 500. Compute profiles 700 may provide a scaling policy for compute clusters 504 in the same COG 500 that are the same size. These compute clusters 504 have the same compute map. A compute map may provide the information as to which compute cluster 504 is the receive certain queries based on the policies.

In FIG. 7, the two different COGs are defined in a COG listing 702, Group 1 and Group 2. The POGs 500 may also maintain the compute profiles 700, which, in this example, includes three different compute profiles 700. Compute profiles 700 include two Group 1 compute profiles, G1_COG1 and G1_COG2 and one Group 1 compute profile, G2_COG1. Each of these compute profiles 700 may be associated with a particular COG map 704. Each COG map 704 may be maintained in the POGs 500 and provides a particular size of compute cluster 504. This allows each compute profile 700 to set a number of compute nodes 600 available at desired time. Each COG map 704 determines how many compute clusters 600 and type are associated with COG map 704 maintained in the POGs 500.

In the example if FIG. 7, two COGs 502 have been created and maintained in a COG list 704 in the POGs 500. As shown, the Group 1 COG is currently running two compute clusters 504, the maps of which are identified in the COG map table 706. The compute profiles 700 will define the amount of compute nodes 600 to be instantiated at specific times. In the example of FIG. 7, the Group 1 COG currently has a compute cluster 504 of size/type COG_MAP_SM. A Group 1 query 708 may be received by the POGs 500 and planned by the optimizer 208.

During operation, queries Q1 and Q2 may be received by the POG 500. Eventually, one or more optimizers 208 will establish query plans for each query Q1 and Q2. In the example of FIG. 7, the optimizer 208 may identify via the COG listing 702 and compute profiles 700 that compute clusters 504 are to receive one or more steps of the query plans. In one example, the COG profile 700 may identify the appropriate COG map 704 to be used for a particular query. In the example of FIG. 7, the optimizer 208, through COG group listing 702, compute profiles 700, and COG maps 704, may determine which compute cluster 504 is to receive any steps of queries Q1 and Q2. Once established, the optimizer 208 may send both the query steps and associated map to the COG router 512.

The COG router 512 may receive one or more steps for queries Q1 and Q2 along with the associated maps. In the example of FIG. 7, two compute clusters 504 are shown for each COG group 502, Group 1 and Group 2. The Group 1 compute cluster includes both a medium compute cluster 504 and a small compute cluster 504. In instances where more than one compute cluster 504 is available and suitable for a query, the compute cluster having the highest number of compute nodes 600 may be chosen. In this example, steps of Q1 are routed to the medium compute cluster 504. As discussed with query strategies, the computer clusters 504 may use standard compute nodes 600 and analytic compute nodes 600. In the example of FIG. 7, the COG Group 2 includes both small and large analytic compute clusters 504 with the steps of query Q2 being routed to the large analytic compute cluster 504. After completion of the query steps, the results may be sent to spools 706 to hold the respective results of each query to be subsequently processed or returned.

Table 1 below provides an example of SQL commands that may be used to establish various parameters regarding COGs 502 and compute clusters 504 allowing autoscaling of system resources to be implemented. While Table 1 describes commands in SQL, the functionality of the SQL statements may be extended to other suitable languages.

TABLE 1

| Database Function | SQL Statement |
|---|---|
| Create Department | CREATE COMPUTE GROUP Customer_Domestic USING |
| Resource Group | QUERY_STRATEGY(‘STANDARD’); |
| Create Compute | CREATE COMPUTE PROFILE Morning_Resource IN |
| Resource | Customer_Domestic, |
| | INSTANCE = TD_COMPUTE_TINY, INSTANCE TYPE = |
| | STANDARD - resource associates the capabilities to a map |
| | USING |
| | MIN_COMPUTE_COUNT(1) |
| | MAX_COMPUTE_COUNT(3) - Enables autoscaling |
| | COOLDOWN_PERIOD(‘30’) |
| | START_TIME(‘45 17* * *’) - 10:45 AM PST |
| | END_TIME(‘0 18 * * *’) - 11:00 AM PST |
| | INITIALLY_SUSPENDED(‘FALSE’); |
| Modify Compute | MODIFY COMPUTE PROFILE Morning_Resource IN |
| Resource | Customer_Domestic |
| | USING |
| | MIN_COMPUTE_COUNT(1) |
| | MAX_COMPUTE_COUNT(5); - Enables autoscaling |
| Suspend Compute | SUSPEND COMPUTE FOR COMPUTE PROFILE SUSPEND |
| Resource | Morning_Resource IN Customer_Domestic; |
| Resume Compute | RESUME COMPUTE FOR COMPUTE PROFILE |
| Resource | Morning_Resource IN Customer_Domestic; |
| Drop Compute | DROP COMPUTE PROFILE Morning_Resource in |
| Resource | Customer_Domestic; |
| Drop Department | DROP COMPUTE PROFILE Morning_Resource in |
| Resource Group | Customer_Domestic; |

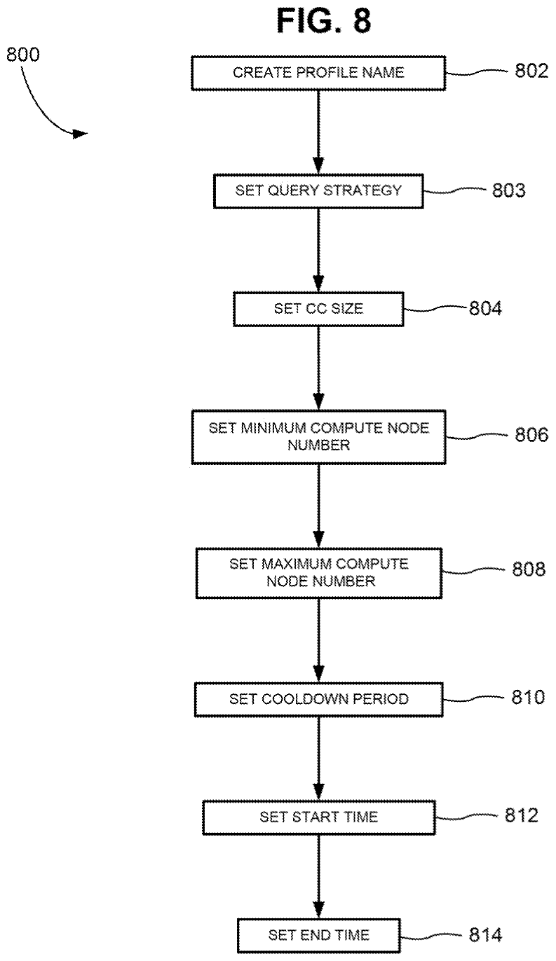

FIG. 8 is an operational flow diagram of an example of creation of a compute profile 700 (800). In one example, a compute profile name may be created (802). Referencing Table 1, this may be accomplished through the CREATE COMPUTE PROFILE Morning Resource IN Customer Domestic, which creates the compute profile name “Morning_Resource in the COG “Customer_Domestic”. The size of the compute cluster 504 (803) and query strategy (804) may then be set. Referencing Table 1, in one example, the INSTANCE=TD_COMPUTE_TINY, INSTANCE TYPE=STANDARD command indicates a compute instance with a total compute cluster count of “TINY”, which may be a predetermined number and the created instance may be for standard processing as a query strategy.

A minimum number of compute clusters 600 may be established for the profile (806). Referencing Table 1, this may be done through the MIN_COMPUTE_COUNT(1) command, which in this example, sets the minimum number of compute nodes 600 to be operational in a compute cluster 504. This allows non-usage to result in any compute nodes 600 above the minimum amount being shut down to reduce resource waste. The maximum number of compute nodes 600 may be set (808). Referencing Table 1, this may be done through the MAX_COMPUTE_COUNT(3) command. This allows a maximum amount to be established which allows a limit to be less than all of the compute clusters 600 in a compute cluster 504 if desired. Through the use of the minimum and maximum limits, a compute cluster 504 may be autoscaled allowing the number of compute nodes 600 to be active to be between the minimum and maximum level based on the workload experiences by the compute cluster 504.

A cooldown period may also be established (810). Referencing Table 1, this may be done through the COOLDOWN_PERIOD(‘30’) command. This command allows a window of time in over which a compute node 600 is to be shut down if no new work has been received, or other identified condition, which in this example is thirty minutes. The cooldown period allows compute nodes 600 still completing tasks the opportunity to complete those tasks. A start time (812) and end time (814) may also be established. Referencing Table 1, the start time may be set through the command START_TIME(‘45 17 * * *’) and the end time through the command END_TIME(‘0 18 * *’). These commands allow the start of end times of over which each compute cluster 504 is to be instantiated.

Various other commands may be implemented as shown in Table 1, such as modifying, suspending, resuming, and dropping compute profiles 700, as well as, dropping a COG 502.

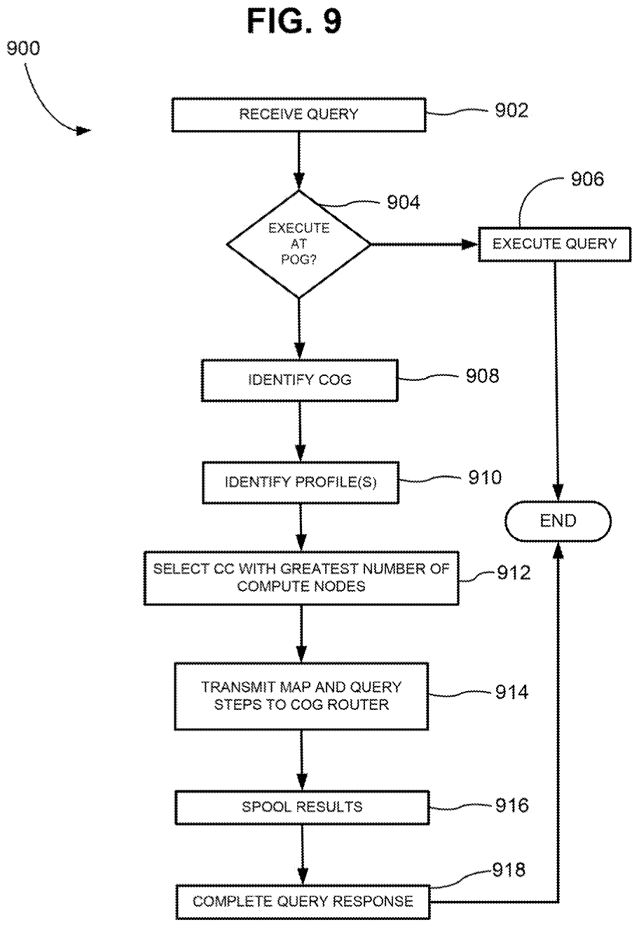

FIG. 9 is an operational flow diagram of example operation (900) of the POG 500. In one example, the POG 500 may receive a query (902). The POG 500 may determine if the query is to be executed at the POG 500 (904). If so, the POG 500 may execute the query (906). If the query is to be executed by a compute cluster 504, the POG 500 may analyze the query to identify the COG 502 (908), which may be done through characteristics of the query and the COG listings 702. The POG 500, through query analysis, may also identify the compute profiles 700 associated with the query via the compute profiles 700 (910). In one example, multiple compute profiles 700 may be appropriate based on the query, in which case, the POG 500 may select the compute cluster 504 having the highest number of compute nodes 600 (912). Once the appropriate compute cluster 504 is selected, the POG 500 may send the COG map information and query steps to the COG router 512 (914). The POG 500 may spool results received from the compute cluster 504 (916). The POG 500 may complete the query response using the spooled results (918).

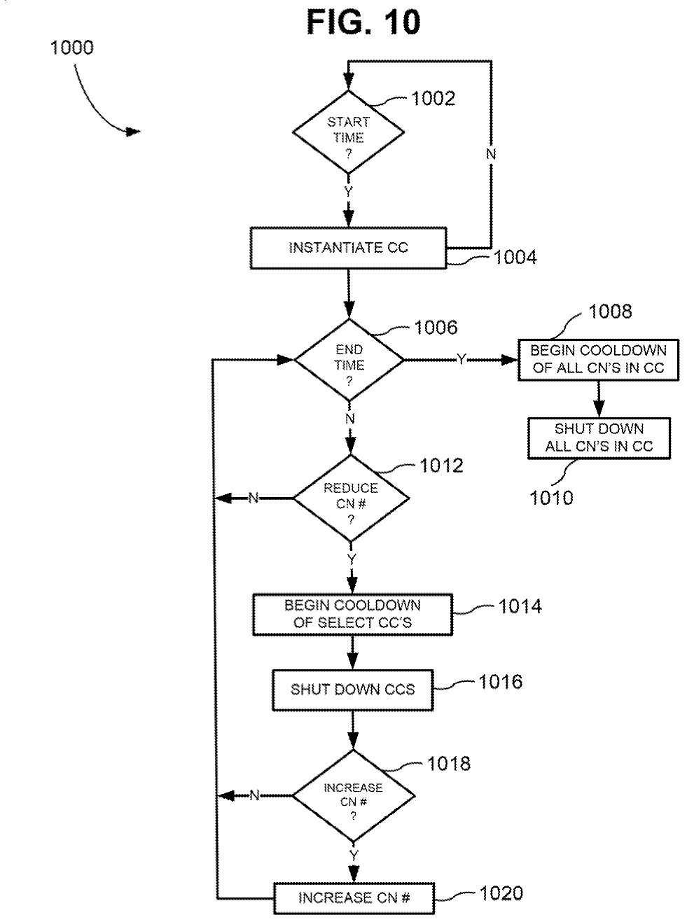

FIG. 10 is an operational flow diagram of example operation 1000 of the POG 500 during usage of a compute cluster 504. In one example, once a start time has been reached (1002), the POG 500 may instantiate a compute cluster 504 for the appropriate COG 500. Once instantiated, the compute cluster 504 may operate. If the end time of the compute cluster 504 is reached, the compute cluster 504 may begin a cooldown period (1008). Once the cooldown period has expired, the compute nodes 600 in the compute cluster 504 may be shut down (1010). If the end time has not been reached, the compute cluster 504 may continue to operate. If the workload is such that not all compute nodes 600 are busy, the POG 500 may determine if the number of compute nodes 600 may be reduced according to the compute profile (1012). If reduction is not to occur, the compute cluster 504 may continue to be fully active. If reduction is to occur, the cooldown of selected computed clusters may be initiated (1014) with the compute nodes 600 being shut down after the cooldown period (1016).

If the compute cluster 600 number of the COG 500 has been reduced and the nodes 504 continues to operate, a determination may be made to increase the number of compute nodes 600 if the workload increases (1018). If such a determination is made, the number of compute nodes 600 may be increased in the COG 504.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

We claim:

1. A system comprising:
a storage device;
a plurality of processing nodes configured to communicate with the storage device, wherein at least one processing node is configured to:
schedule a group of compute nodes to be active during a selected time window;
receive a query;
determine that the query is to be executed by one of the plurality of processing nodes and the group of compute nodes; and
schedule the query to be executed by the determined one of the plurality of processing nodes or the group of compute nodes.

2. The system of claim 1, wherein the at least one processing node is configured to:
execute a policy that defines a type of query that is be executed by the group of compute nodes.

3. The system of claim 2, wherein the group of compute nodes has a total number of compute nodes, and the policy defines a number of compute nodes to be active in the group of compute nodes of the total number during selected time windows.

4. The system of claim 2, wherein the policy defines a total number of compute nodes in the group of compute nodes.

5. The system of claim 1, wherein a number of active compute nodes in the group of compute nodes is reduced based on inactivity.

6. The system of claim 1, wherein the at least one processing node is configured to: schedule a plurality of groups of compute nodes to be active during respective time windows; and
receive a plurality of queries, wherein the policy defines which group of compute nodes is to receive one of the plurality of queries based on a source of the one of the plurality of queries.

7. The system of claim 6, wherein at least one processing node is configured to identify a total number of compute nodes in each of the plurality of groups of compute nodes based on a map.

8. A method comprising:
scheduling, with a processor, a group of compute nodes to be active during a selected time window;
receiving, with the processor, a query;
determining, with the processor, that the query is to be executed by one of the plurality of processing nodes and the group of compute nodes; and
scheduling, with the processor, the query to be executed by the determined one of the plurality of processing nodes or the group of compute nodes.

9. The method of claim 1, further comprising executing, with the processor, a policy that defines a type of query that is be executed by the group of compute nodes.

10. The method of claim 9, wherein the group of compute nodes has a total number of compute nodes, and the policy defines a number of compute nodes to be active in the group of compute nodes of the total number during selected time windows.

11. The method of claim 9, wherein the policy defines a total number of compute nodes in the group of compute nodes.

12. The method of claim 8, wherein a number of active compute nodes in the group of compute nodes is reduced based on inactivity.

13. The method of claim 8, further comprising:
scheduling, with the processor, a plurality of groups of compute nodes to be active during respective time windows; and
receiving, with the processor, a plurality of queries, wherein the policy defines which group of compute nodes is to receive one of the plurality of queries based on a source of the one of the plurality of queries.

14. The method of claim 13, wherein at least one processing node is configured to identify a total number of compute nodes in each of the plurality of groups of compute nodes based on a map.

15. A computer-readable medium encoded with a plurality of instructions executable by a processor, wherein the plurality of instructions comprises:
instructions to schedule a group of compute nodes to be active during a selected time window;
instruction to receive a query;
instructions to determine that the query is to be executed by one of the plurality of processing nodes and the group of compute nodes; and
instructions to schedule the query to be executed by the determined one of the plurality of processing nodes or the group of compute nodes.

16. The computer-readable medium of claim 15, wherein the plurality of instructions further comprises instructions to execute a policy that defines a type of query that is be executed by the group of compute nodes.

17. The computer-readable medium of claim 16, wherein the group of compute nodes has a total number of compute nodes, and the policy defines a number of compute nodes to be active in the group of compute nodes of the total number during selected time windows.

18. The computer-readable medium of claim 16, wherein the policy defines a total number of compute nodes in the group of compute nodes.

19. The computer-readable medium of claim 15, wherein a number of active compute nodes in the group of compute nodes is reduced based on inactivity.

20. The computer-readable medium of claim 15, wherein the plurality of instructions further comprises:
instructions to schedule a plurality of groups of compute nodes to be active during respective time windows; and
instructions to receive a plurality of queries, wherein the policy defines which group of compute nodes is to receive one of the plurality of queries based on a source of the one of the plurality of queries.
